(19) United States
(12) Patent Application Publication
(10) Pub. No.: US 2007/0189587 A1
(43) Pub. Date: Aug. 16, 2007

(54) Method and apparatus corresponding to an asperity detection sensor surface

(76) Inventor: Carl N. Garcia, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/353,483

(22) Filed: Feb. 14, 2006

(51) Int. Cl. G06K 9/00

(52) U.S. Cl. 382/124

(57) ABSTRACT

A plurality of contact sensor pixel elements (202) are provided (101) along with a plurality of electrically conductive balls (302, 403). By one approach these balls are each sized at least substantially similar to the contact sensor pixel elements. If desired, by one approach, these balls are provided in a pre-arranged pattern separate from the plurality of contact sensor pixel elements. By one approach this pre-arranged pattern provides for alignment and registration of the balls with the contact sensor pixel elements when the two are brought into contact with one another. Each of the plurality of electrically conductive balls is then affixed in contact with one of the plurality of contact sensor pixel elements such that substantially none of the plurality of contact sensor pixel elements contacts more than one of the electrically conductive balls.

### TECHNICAL FIELD

This invention relates generally to asperity detection surfaces.

### BACKGROUND

Asperity detection surfaces that employ electrically conductive substantially spherical members are known. In such a configuration, the electrically conductive substantially spherical members typically serve as an electrically conductive path between asperities of interest (such as human fingerprint ridges) and asperity detection/storage cells. In such an arrangement, a sensor array may comprise a plurality of small contact sensor pixel elements that are separated from one another by relatively small distances. Each such contact sensor pixel element typically has a plurality of corresponding substantially spherical members contacting or otherwise associated therewith.

These substantially spherical members tend to be relatively small as compared, for example, to the sensor pixel elements. An asperity detection sensor surface configured to achieve 1,000 dot per inch (dpi) resolution, for example, may have contact sensor pixel elements that are approximately 19.8 microns on a side and that are spaced about 5.6 microns from one another while the substantially spherical members might range from about 5 to 9 microns in diameter.

Asperity detector sensor surfaces configured as described can provide satisfactory operability under at least some operating conditions. Unfortunately, such a configuration tends to permit only a relatively thin epoxy (or other protective material) coating to separate the sensor pixel elements from environmental stresses. This occurs at least in part because, as a general rule, this protective coating should not be so thick as to completely cover and obscure the substantially spherical members themselves. There are times, however, when a thicker coating, providing greater durability and ruggedness, is desired. Furthermore, these problems become more acute as sensor resolution increases (and hence substantially spherical member size decreases).

### BRIEF DESCRIPTION OF THE DRAWINGS

The above needs are at least partially met through provision of the method and apparatus corresponding to an asperity detection sensor surface described in the following detailed description, particularly when studied in conjunction with the drawings, wherein:

FIG. 1 comprises a flow diagram as configured in accordance with various embodiments of the invention;

FIG. 2 comprises a top plan schematic view as configured in accordance with various embodiments of the invention;

FIG. 3 comprises a side elevational schematic view as configured in accordance with various embodiments of the invention;

FIG. 4 comprises a side elevational schematic view as configured in accordance with various embodiments of the invention;

FIG. 5 comprises a top plan schematic view as configured in accordance with various embodiments of the invention; and

FIG. 6 comprises a top plan schematic view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a plurality of contact sensor pixel elements are provided along with a plurality of electrically conductive balls. By one approach these balls are each sized at least substantially similar to the contact sensor pixel elements. If desired, by one approach, these balls are provided in a pre-arranged pattern separate from the plurality of contact sensor pixel elements. By one approach this pre-arranged pattern provides for alignment and registration of the balls with the contact sensor pixel elements when the two are brought into contact with one another. Each of the plurality of electrically conductive balls is then affixed in contact with one of the plurality of contact sensor pixel elements such that substantially none of the plurality of contact sensor pixel elements contacts more than one of the electrically conductive balls.

If desired, at least a substantial number of the plurality of electrically conductive balls is each sized larger than the contact sensor pixel elements. This, in turn, may tend to result in at least some of the electrically conductive balls contacting one another once placed in contact with a corresponding sensor pixel element. By one approach these electrically conductive balls can be comprised of a material (such as nickel) that tends to exhibit relatively poor electrical conductivity when in an uncompressed state and relatively better electrical conductivity when in a compressed state (as when an asperity surface contacts the electrically conductive balls).

So configured, considerably larger substantially spherical members can be employed as compared to prior art structures. For example, while the prior art might employ substantially spherical members having a 5 to 9 micron diameter when accommodating a 1,000 dpi asperity detection sensor surface, these teachings permit use of substantially spherical members having upwards of a 20 micron diameter or even a 24 micron diameter. These larger-sized balls, in turn, permit a significant increase in the thickness of any corresponding protective coating. A corresponding increase in durability and ruggedness then permits deployment and use of asperity detection sensor surfaces in application settings that might have previously been inappropriate or inadvisable.

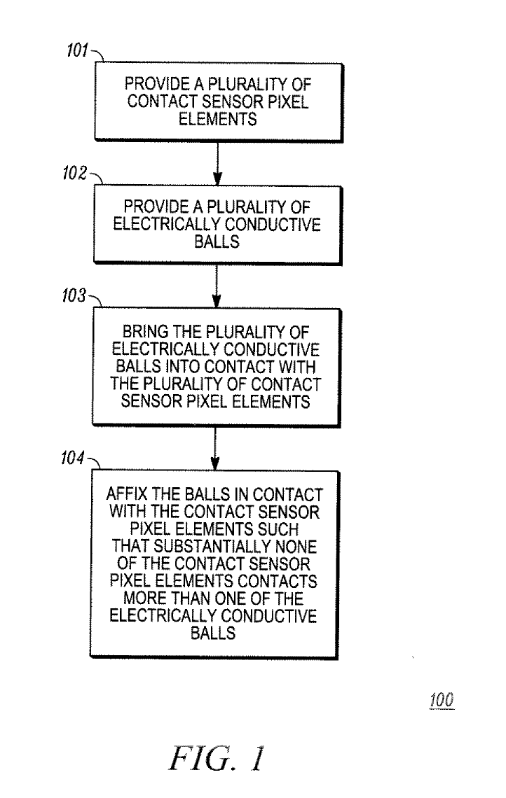

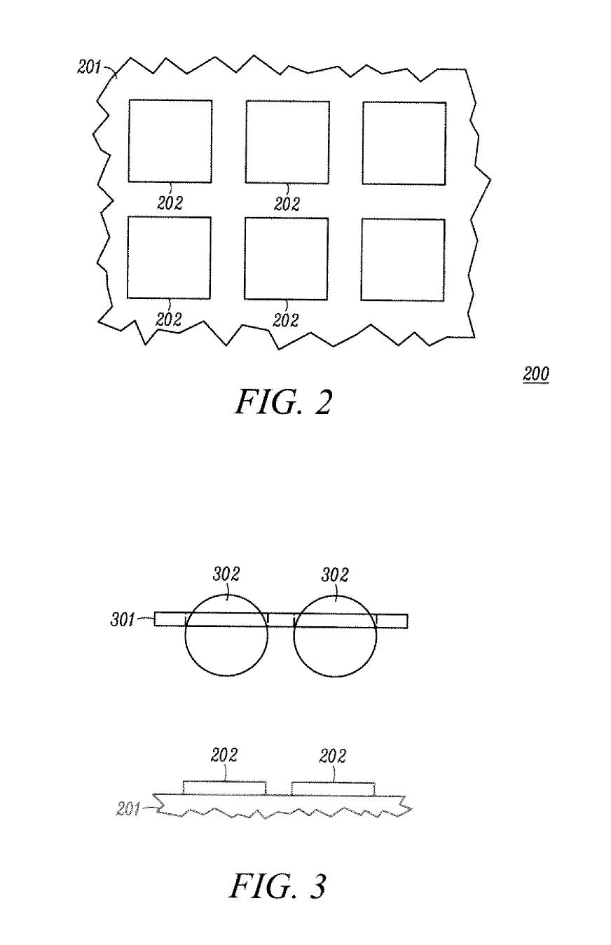

These and other benefits may become clearer upon making a thorough review and study of the following detailed description. Referring now to the drawings, and in particular to FIG. 1, a corresponding illustrative process 100 provides 101 a plurality of contact sensor pixel elements. By one approach, the contact sensor pixel elements of this plurality each share a substantially similar relative size. For example, and referring momentarily to FIG. 2, a corresponding structure 200 can comprise a plurality of substantially square-shaped contact sensor elements 202 (formed, for example, of an electrically conductive metal) that are substantially equally distributed on, for example, an undoped oxide layer 201. For purposes of illustration and not limitation, to achieve sensor resolution of, for example, 1,000 dpi these contact sensor elements 202 may be approximately 19.8 microns per side and may be spaced approximately 5.6 microns apart from one another.

Those skilled in the art will recognize and understand that an asperity detector will typical comprise additional elements. For example, the above-described undoped oxide layer 201 will itself typically comprise a part of a laminate structure that comprises additional metal layers, a borophosphosilicate glass and field oxide layer, and a silicon wafer base. As various such structures and methods of forming them are already known in the art, for the sake of brevity additional elaboration regarding such details will not be presented here.

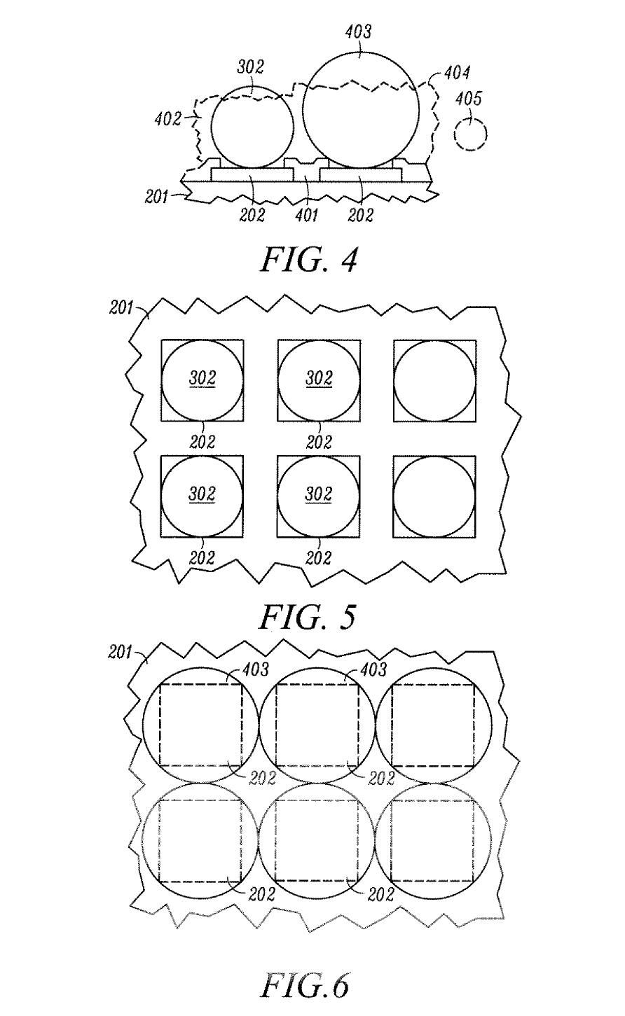

If desired, and referring momentarily to FIG. 4, insulating boundary elements 401 can be formed between some or all of the contact sensor elements 202. Such elements 401 can have, for example, a trough-like side-elevational shape and can be comprised, for example, of glass or the like. Such elements 401 can serve, for example, to aid in properly positioning electrically conductive balls as are described below. Again, the notion of using insulating boundary elements between contact sensor elements on an asperity detection sensor surface is generally known in the art and requires no further elaboration here.

Referring again to FIG. 1, this process 100 also provides 102 for a plurality of electrically conductive balls (e.g., substantially spherical members). By one approach these electrically conductive balls are each sized at least substantially similar to the sensor pixel elements. An illustrative example of such an electrically conductive ball appears in FIGS. 4 and 5 as denoted by reference character 302.

By one approach, if desired, at least a substantial number of the plurality of electrically conductive balls can be sized larger than the contact sensor pixel elements 202. An illustrative example of such an electrically conductive ball appears in FIGS. 4 and 6 as denoted by reference character 403. So configured, of course, it becomes more likely that at least some of the electrically conductive balls 403 will physically contact one another when disposed on the contact pixel elements 202 as disclosed below. If desired, some or all of these electrically conductive balls 302 and 403 can be comprised of material (such as nickel) that tends to exhibit relatively poor electrical conductivity when in an uncompressed state and relatively better electrical conductivity when in a compressed state as when an asperity surface contacts the electrically conductive ball. This, in turn, can aid in preventing undesired electrical shorting and cross-talk between contact sensor pixel elements.

Referring again to FIG. 1, by one approach this plurality of electrically conductive balls is then brought 103 into contact with the plurality of contact sensor pixel elements. This can comprise, for example, providing or ensuring that substantially none of the plurality of contact sensor pixel elements contacts more than one of the electrically conductive balls. Such an arrangement and such one-to-one juxtapositioning appears in the illustrative embodiments of FIGS. 4, 5, and 6. Such an arrangement, of course, varies dramatically from typical prior art practice where one more ordinarily endeavors to provide a plurality of balls in contact with each contact sensor pixel element.

There are various ways by which the plurality of electrically conductive balls may be so brought into contact with the plurality of contact sensor pixel elements. By one approach, if desired, the plurality of electrically conductive balls is provided in a pre-arranged pattern separate from the plurality of contact sensor pixel elements. There are various ways by which such a pre-arranged pattern can be realized. By one approach an electroformed sieve can serve to define the pre-arranged pattern. With momentary reference to FIG. 3, such a sieve 301 can provide apertures to receive the electrically conductive balls 302 (for example, by simply deploying the electrically conductive balls 302 loosely over the surface of the sieve 301).

The electrically conductive balls 302 may then be held in place using a force or influence of choice. Example influences include, but are not limited to, a vacuum, a magnetic field, an electric field, vibration, ultrasonic energy, and a temporary adhesive. Those skilled in the art will recognize that a particular influence (or influences) to employ in a given application setting will likely vary with respect to such factors as the size and/or material composition of the electrically conductive balls.

The sieve 301 and the momentarily restrained electrically conductive balls 302 may then be brought towards the aforementioned contact sensor pixel elements 202 to thereby properly position the electrically conductive balls 302 in contact with respective contact sensor pixel elements 202. The sieve 301 may then be removed or remain in place (either temporarily or permanently) as depends upon the manufacturing preferences as correspond to a particular setting. (Those skilled in the art will understand that other pattern arrangement mechanisms can be employed other than an electroformed sieve. For example, a particle alignment and pickup surface could be formed using laser etching, chemical etching, photo-deposition techniques, or microelectromechanical system (MEMS)-type fabrication techniques.)

Referring again to FIG. 1, the electrically conductive balls are then each affixed 104 in place in contact with a respective one of the plurality of contact sensor pixel elements such that substantially none of the plurality of contact sensor pixel elements contacts more than one of the electrically conductive balls. There are various ways by which such affixment can be achieved. By one approach, and referring again to FIG. 4, an epoxy 402 can be disposed over the surface that comprises, in part, the contact sensor pixel elements 202 to thereby adhere the plurality of electrically conductive balls 302 in place with respect to the contact sensor pixel elements. In a typical approach the adherent would be disposed on the contact sensor pixel element surface prior to urging the electrically conductive balls towards that surface. Such epoxies and their use for such a purpose are known in the art.

Those skilled in the art will appreciate as well that a portion of at least a substantial number of the plurality of electrically conductive balls should extend beyond an outer exposed surface of the epoxy to provide an appropriate measure of performance sensitivity. Of course, when relatively larger sized electrically conductive balls 403 are employed, a relatively thicker layer of epoxy 404 may be similarly applied. In either case, however, it will be understood and appreciated that the thickness of the resultant epoxy layer can be considerably thicker (by upwards of a multiple of four or five times) than as would be otherwise expected when using a more traditional smaller sized ball (such as the illustrative ball denoted by reference character 405 that has been provided in the figure for comparison purposes). This thicker layer, in turn, provides considerably improved electrical and mechanical protection for the contact sensor pixel elements and/or other underlying elements of the asperity detector.

Those skilled in the art will also understand and appreciate that the larger sized electrically conductive balls employed in these teachings will tend to provide correspondingly increased electrostatic discharge protection for the underlying sensor devices. By one measure, for example, an increase of 65 to 110 times existing protection as is associated with smaller-sized spheres can be expected via use of these teachings.

These same teachings can be employed on a smaller scale to permit fabrication of asperity detectors offering higher degrees of resolution with similar benefits. For example, greatly increased resolution can be obtained by reducing the contact sensor pixel elements and their corresponding electrically conductive balls by a factor of, for example, four. This will reduce the diameter of the electrically conductive balls to about 5 microns. This, of course, comports with today's supportable technology. The corresponding adherent layer would then be as thin as today's much lower resolution asperity detectors but still considerably better than what one might expect using today's approaches with higher resolution platforms.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

What is claimed is:

1. An asperity detection sensor surface comprising:
a plurality of sensor pixel elements disposed on a surface;
a plurality of electrically conductive balls that are each sized at least substantially similar to the sensor pixel elements, with only one of the plurality of balls being fixed in contact with each of at least most of the plurality of sensor pixel elements;
such that an asperity surface that contacts a given one of the plurality of electrically conductive balls will be thereby electrically coupled to an underlying corresponding one of the sensor pixel elements.

2. The asperity detection sensor surface of claim 1 wherein the plurality of sensor pixel elements comprise at least 1000 dot per inch sensor pixel elements.

3. The asperity detection sensor surface of claim 1 wherein the plurality of electrically conductive balls are comprised of material that tends to exhibit relatively poor electrical conductivity when in an uncompressed state and relatively better electrical conductivity when in a compressed state as when an asperity surface contacts the electrically conductive ball.

4. The asperity detection sensor surface of claim 3 wherein at least a substantial number of the plurality of electrically conductive balls are each sized larger than the sensor pixel elements and wherein at least some of the plurality of electrically conductive balls as each contact a given one of the sensor pixel elements are in contact with one another.

5. The asperity detection sensor surface of claim 1 further comprising:
an epoxy disposed over the surface to adhere the plurality of electrically conductive balls in place with respect to the sensor pixel elements.

6. The asperity detection sensor surface of claim 5 wherein a portion of at least a substantial number of the plurality of electrically conductive balls extend beyond an outer exposed surface of the epoxy.

7. A method comprising:
providing a plurality of contact sensor pixel elements;
providing a plurality of electrically conductive balls that are each sized at least substantially similar to the contact sensor pixel elements;
affixing each of the plurality of electrically conductive balls in contact with one the plurality of contact sensor pixel elements such that substantially none of the plurality of contact sensor pixel elements contacts more than one of the electrically conductive balls.

8. The method of claim 7 wherein providing a plurality of contact sensor pixel elements comprises providing a plurality of contact sensor pixel elements having a relative size, spacing, and density sufficient to serve as at least 1000 dot per inch sensor pixel elements.

9. The method of claim 7 wherein providing a plurality of electrically conductive balls comprises providing a plurality of electrically conductive balls that are each comprised of material that tends to exhibit relatively poor electrical conductivity when in an uncompressed state and relatively better electrical conductivity when in a compressed state as when an asperity surface contacts the electrically conductive ball.

10. The method of claim 9 wherein providing a plurality of electrically conductive balls further comprises providing a plurality of electrically conductive balls wherein at least a substantial number of the plurality of electrically conductive balls are each sized larger than the contact sensor pixel elements and wherein at least some of the plurality of electrically conductive balls as each contact a given one of the contact sensor pixel elements are in contact with one another.

11. The method of claim 7 wherein affixing each of the plurality of electrically conductive balls in contact with one the plurality of contact sensor pixel elements comprises using epoxy to effect, at least in part, the affixing.

12. The method of claim 7 wherein providing a plurality of electrically conductive balls comprises:
providing the plurality of electrically conductive balls in a pre-arranged pattern separate from the plurality of contact sensor pixel elements;
bringing the plurality of electrically conductive balls in the pre-arranged pattern into contact with the plurality of contact sensor pixel elements.

13. The method of claim 12 wherein providing the plurality of electrically conductive balls in a pre-arranged pattern separate from the plurality of contact sensor pixel elements comprises using an electroformed sieve to define the pre-arranged pattern.

14. The method of claim 13 wherein providing the plurality of electrically conductive balls in a pre-arranged pattern separate from the plurality of contact sensor pixel elements further comprises temporarily holding the plurality of electrically conductive balls in place with respect to the electroformed sieve by use of at least one of:
a vacuum;
a magnetic field;
an electric field;
vibration;
ultrasonic energy;
a temporary adhesive.

15. A method comprising:
providing a plurality of contact sensor pixel elements;
providing a plurality of electrically conductive balls in a pre-arranged pattern separate from the plurality of contact sensor pixel elements;
bringing the plurality of electrically conductive balls in the pre-arranged pattern into contact with the plurality of contact sensor pixel elements;
affixing each of the plurality of electrically conductive balls in contact with one the plurality of contact sensor pixel elements such that substantially none of the plurality of contact sensor pixel elements contacts more than one of the electrically conductive balls.

16. The method of claim 15 wherein providing the plurality of electrically conductive balls in a pre-arranged pattern separate from the plurality of contact sensor pixel elements comprises using an electroformed sieve to define the pre-arranged pattern.

17. The method of claim 16 wherein providing the plurality of electrically conductive balls in a pre-arranged pattern separate from the plurality of contact sensor pixel elements further comprises temporarily holding the plurality of electrically conductive balls in place with respect to the electroformed sieve by use of at least one of:
a vacuum;
a magnetic field;
an electric field;
vibration;
ultrasonic energy;
a temporary adhesive.

18. The method of claim 15 wherein providing a plurality of electrically conductive balls comprises providing a plurality of electrically conductive balls that are each sized at least substantially similar to the contact sensor pixel elements.

19. The method of claim 15 wherein providing a plurality of electrically conductive balls comprises providing a plurality of electrically conductive balls that are each comprised of material that tends to exhibit relatively poor electrical conductivity when in an uncompressed state and relatively better electrical conductivity when in a compressed state as when an asperity surface contacts the electrically conductive ball.

20. The method of claim 19 wherein providing a plurality of electrically conductive balls further comprises providing a plurality of electrically conductive balls wherein at least a substantial number of the plurality of electrically conductive balls are each sized larger than the contact sensor pixel elements and wherein at least some of the plurality of electrically conductive balls as each contact a given one of the contact sensor pixel elements are in contact with one another.
